(19) United States
(12) Patent Application Publication
(10) Pub. No.: US 2018/0307720 A1
(43) Pub. Date: Oct. 25, 2018

(54) SYSTEM AND METHOD FOR LEARNING-BASED GROUP TAGGING

(71) Applicant: BEIJING DIDI INFINITY TECHNOLOGY AND DEVELOPMENT CO., LTD., Beijing (CN)

(72) Inventors: Wenjun YANG, Beijing (CN); Zang LI, Beijing (CN); Hongbo LING, Beijing (CN); Lifeng CAO, Beijing (CN); Zhihua CHANG, Beijing (CN); Fan YANG, Beijing (CN)

(73) Assignee: BEIJING DIDI INFINITY TECHNOLOGY AND DEVELOPMENT CO., LTD., Beijing (CN)

(21) Appl. No.: 15/979,556

(22) Filed: May 15, 2018

Related U.S. Application Data
(63) Continuation of application No. PCT/CN2017/081279, filed on Apr. 20, 2017.

(51) Int. Cl. G06F 17/30; G06F 7/20; G06N 5/02

(52) U.S. Cl. CPC G06F 17/30377; G06N 5/025; G06F 7/20

(57) ABSTRACT

Systems and methods are provided for group tagging. Such system may comprise processors accessible to platform data that comprises a plurality of users and a plurality of associated data fields, and a memory storing instructions that, when executed by the processors, cause the system to perform a method. The method may comprise obtaining a first subset users and associated first tags; determining, respectively for the associated data fields, at least a difference between the first subset users and at least some of the plurality of users; responsive to determining the difference exceeding a first threshold, determining the data field as a key data field; determining data of the corresponding key data fields associated with the first subset users as positive samples; obtaining, based on the key data fields, a second subset users and associated data as negative samples; and training a rule model with the positive and negative samples.

### CROSS-REFERENCE TO RELATED APPLICATIONS

This application is a continuation of International Application No. PCT/CN2017/081279 filed on Apr. 20, 2017, the entire contents of which are incorporated herein by reference.

### FIELD OF THE INVENTION

This disclosure generally relates to approaches and techniques for user tagging and learning-based tagging.

### BACKGROUND

A platform may provide various services to users. To facilitate user service and management, it is desirable to organize the users in groups. This process can bring many challenges, especially if the number of users becomes large.

### SUMMARY

Various embodiments of the present disclosure can include systems, methods, and non-transitory computer readable media configured to perform group tagging. A computing system for group tagging may comprise one or more processors accessible to platform data and a memory storing instructions that, when executed by the one or more processors, cause the computing system to perform a method. The platform data may comprise a plurality of users and a plurality of associated data fields. The method may comprise: obtaining a first subset of users and one or more first tags associated with the first subset of users, determining, respectively for one or more of the associated data fields, at least a difference between the first subset of users and at least a part of the plurality of users, in response to determining the difference exceeding a first threshold, determining the corresponding data field as a key data field, determining data of the corresponding one or more key data fields associated with the first subset of users as positive samples, obtaining, based on the one or more key data fields, a second subset of users and associated data from the platform data as negative samples, and training a rule model with the positive and negative samples to obtain a trained group tagging rule model.

In some embodiments, the platform data may comprise tabular data corresponding to each of the plurality of users, and the data fields may comprise at least one of data dimension or data metric.

In some embodiments, the plurality of users may be users of the platform, the platform may be a vehicle information platform, and the data fields may comprise at least one of a location, a number of uses, a transaction amount, or a number of complaints.

In some embodiments, obtaining a first subset of users may comprise receiving identifications of the first subset of users from one or more analysts without full access to the platform data.

In some embodiments, the platform data may not comprise the first tags before the server obtaining the first subset of users.

In some embodiments, the difference may be a Kullback-Leibler divergence.

In some embodiments, the second subset of users may be different from the first subset of users over a third threshold based on a similarity measurement with respect to the one or more key data fields.

In some embodiments, the rule model may be a decision tree model.

In some embodiments, the trained group tagging rule model may determine whether to assign one or more of the plurality of users the first tags.

In some embodiments, the server is further configured to perform applying the trained group tagging rule model to tag the plurality of users and new users added to the plurality of users.

In some embodiments, a group tagging method may comprise obtaining a first subset of a plurality of entities of a platform. The first subset of entities may be tagged with first tags, and platform data may comprise data of the plurality of entities with respect to a one or more data fields. The group tagging method may further comprise determining at least a difference between data of one or more data fields of the first subset of entities and that of some other entities of the plurality of entities. The group tagging method may further comprise, in response to determining the difference exceeding a first threshold, obtaining corresponding data associated with the first subset of entities as positive samples, and corresponding data associated with a second subset of the plurality of entities as negative samples. The group tagging method may further comprise training a rule model with the positive and negative samples to obtain a trained group tagging rule model. The trained group tagging rule model may determine if an existing or new entity is entitled to the first tag.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates an example environment for group tagging, in accordance with various embodiments.

FIG. 2 illustrates an example system for group tagging, in accordance with various embodiments.

FIG. 3A illustrates example platform data, in accordance with various embodiments.

FIG. 3B illustrates example platform data with first tags, in accordance with various embodiments.

FIG. 3C illustrates example platform data with determined positive and negative samples and key data fields, in accordance with various embodiments.

FIG. 3D illustrates example platform data with tagged groups, in accordance with various embodiments.

FIG. 4A illustrates a flowchart of an example method for group tagging, in accordance with various embodiments.

FIG. 4B illustrates a flowchart of another example method for group tagging, in accordance with various embodiments.

FIG. 5 illustrates a block diagram of an example computer system in which any of the embodiments described herein may be implemented.

### DETAILED DESCRIPTION

Group tagging is essential to effective user management. This method can bring a large amount of data into order, and create a basis for further data manipulation, analysis derivation, and value creation. Without group tagging, data processing becomes inefficient, especially when the data volume scales up. Even if a small portion of the data may be tagged manually based on certain “local tagging rules,” such rules are not verified across the global data and may not be appropriate to use globally as is. Further, for various reasons such as data security, limited job responsibility, and lack of skill background, analysts who have direct user interactions to collect first-hand data and perform manual tagging may not be allowed to access the global data, further limiting the extrapolating of the “local tagging rules” to “global tagging rules.”

For example, in an online platform which provides services to a large of users, operation and customer service analysts may directly interact with customers and accumulate the first-hand data. The analysts may also create certain “local tagging rules” based on the interactions, for example, categorizing users of certain similar background or characteristics together. However, the analysts have restricted authorization to the entire platform data and may not access all information associated each user. On the other hand, engineers who have access to the platform data may lack the customer interaction experiences and bases for creating “global tagging rules.” Therefore, it is desirable to utilize the first-hand interaction, refine the “local tagging rules,” and obtain “global tagging rules” which are appropriate and applicable to the platform data in large-scale.

Various embodiments described below can overcome such problems arising in the realm of group tagging. In various implementations, a computing system may perform a group tagging method. The group tagging method may comprise obtaining a first subset of a plurality of entities (e.g., users, objects, virtual representations, etc.) of a platform. The first subset of entities may be each tagged with a first tag following a tagging rule, which may be deemed as a “local tagging rule,” and platform data may comprise data of the plurality of entities with respect to a one or more data fields. The group tagging method may further comprise determining at least a difference between data of one or more data fields of the first subset of entities and that of some other entities of the plurality of entities. The group tagging method may further comprise, in response to determining the difference exceeding a first threshold in certain data field(s) of the one or more data fields, obtaining corresponding data associated with the first subset of entities as positive samples, and obtaining corresponding data associated with a second subset of the plurality of entities of which the data is substantially different from that of the first subset of entities in the certain data field(s) as negative samples. As discussed below, the substantial difference can be determined based on a similarity measurement method. The group tagging method may further comprise training a rule model with the positive and negative samples to obtain a trained group tagging rule model. The trained group tagging rule model can be applied to a part or all of the platform data to determine if an existing or new entity is entitled to the first tag. This determination can be deemed as a “global tagging rule.”

In some embodiments, the entities may comprise users of a platform. A computing system for group tagging may comprise a server accessible to platform data. The platform data may comprise a plurality of users and a plurality of associated data fields. The server may comprise one or more processors accessible to platform data and a memory storing instructions that, when executed by the one or more processors, cause the computing system to obtain a first subset of users and one or more first tags associated with the first subset of users. The instruction may further cause the computing system to determine, respectively for one or more of the associated data fields, at least a difference between the first subset of users and at least a part of the plurality of users. The instruction may further cause the computing system to, in response to determining the difference exceeding a first threshold, determine the corresponding data field as a key data field. The instruction may further cause the computing system to determine data of the corresponding one or more key data fields associated with the first subset of users as positive samples. The instruction may further cause the computing system to obtain, based on the one or more key data fields, a second subset of users and associated data from the platform data as negative samples, the associated data of the second subset of users being substantially different from that of the first subset of entities. The instruction may further cause the computing system to train a rule model with the positive and negative samples to reach a second accuracy threshold (e.g., a threshold of predetermined 98% accurate) to obtain a trained group tagging rule model.

In some embodiments, the platform may be a vehicle information platform. The platform data may comprise tabular data corresponding to each of the plurality of users, and the data fields may comprise at least one of data dimension or data metric. The plurality of users may be users of the platform, and the data fields may comprise at least one of a location of the user, a number of uses of the platform service by the user, a transaction amount, or a number of complaints.

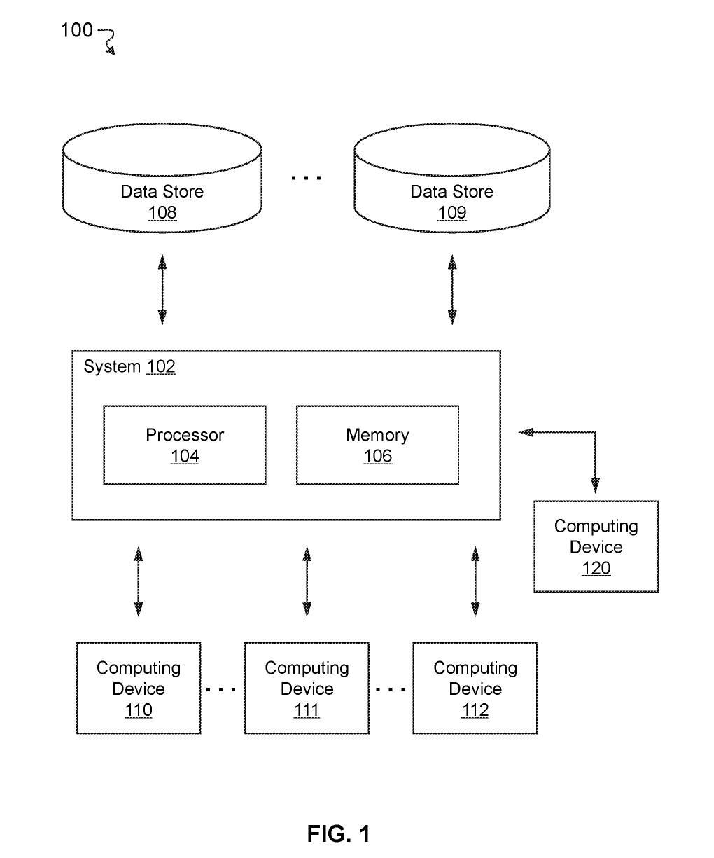

FIG. 1 illustrates an example environment 100 for group tagging, in accordance with various embodiments. As shown in FIG. 1, the example environment 100 can comprise at least one computing system 102 that includes one or more processors 104 and memory 106. The memory 106 may be non-transitory and computer-readable. The memory 106 may store instructions that, when executed by the one or more processors 104, cause the one or more processors 104 to perform various operations described herein. The environment 100 may also include one or more computing devices 110, 111, 112, and 120 (e.g., cellphone, tablet, computer, wearable device (smart watch), etc.) coupled to the system 102. The computing devices may transmit/receive data to/from the system 102 according to their access and authorization levels. The environment 100 may further include one or more data stores (e.g., data stores 108 and 109) that are accessible to the system 102. The data in the data stores may be associated with different access authorization levels.

In some embodiments, the system 102 may be referred to as an information platform (e.g., a vehicle information platform providing information of vehicles, which can be provided by one party to service another party, shared by multiple parties, exchanged among multiple parties, etc.). Platform data may be stored in the data stores (e.g., data stores 108, 109, etc.) and/or the memory 106. The computing device 120 may be associated with a user of the platform (e.g., a user's cellphone installed with an Application of the platform). The computing device 120 may have no access to the data stores, except for which processed and fed by the platform. The computing devices 110 and 111 may be associated with analysts with limited access and authorization to the platform data. The computing device 112 may be associated with engineers with full access and authorization to the platform data.

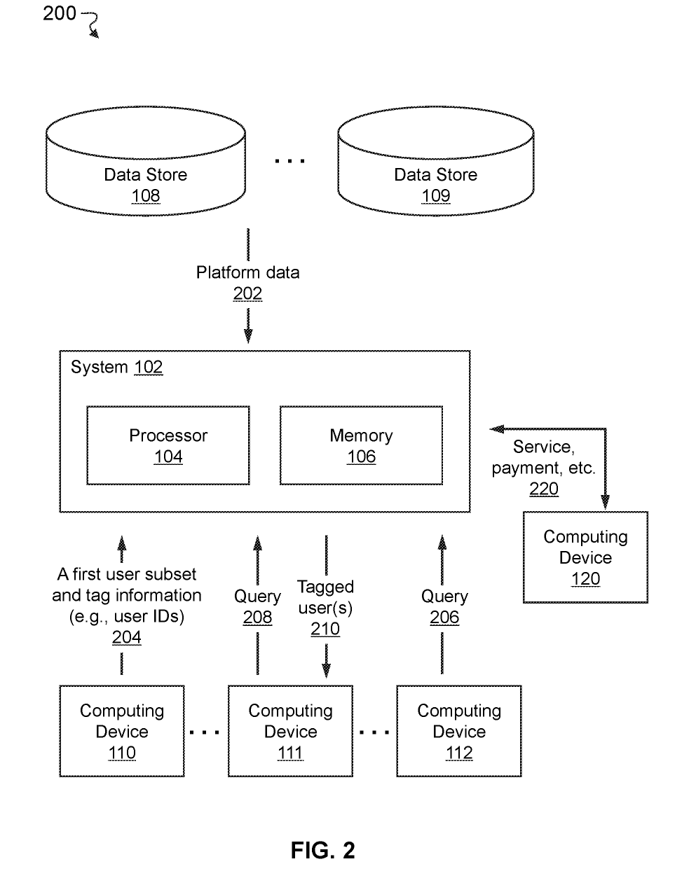

In some embodiments, the system 102 and one or more of the computing devices (e.g., computing device 110, 111, or 112) may be integrated in a single device or system. Alternatively, the system 102 and the computing devices may operate as separate devices. For example, the computing devices 110, 111, and 112 may be computers or mobile devices, and the system 102 may be a server. The data store(s) may be anywhere accessible to the system 102, for example, in the memory 106, in the computing devices 110, 111, or 112, in another device (e.g., network storage device) coupled to the system 102, or another storage location (e.g., cloud-based storage system, network file system, etc.), etc. In general, the system 102, the computing devices 110, 111, 112, and 120, and/or the data stores 108 and 109 may be able to communicate with one another through one or more wired or wireless networks (e.g., the Internet) through which data can be communicated. Various aspects of the environment 100 are described below in reference to FIG. 2 to FIG. 4B.

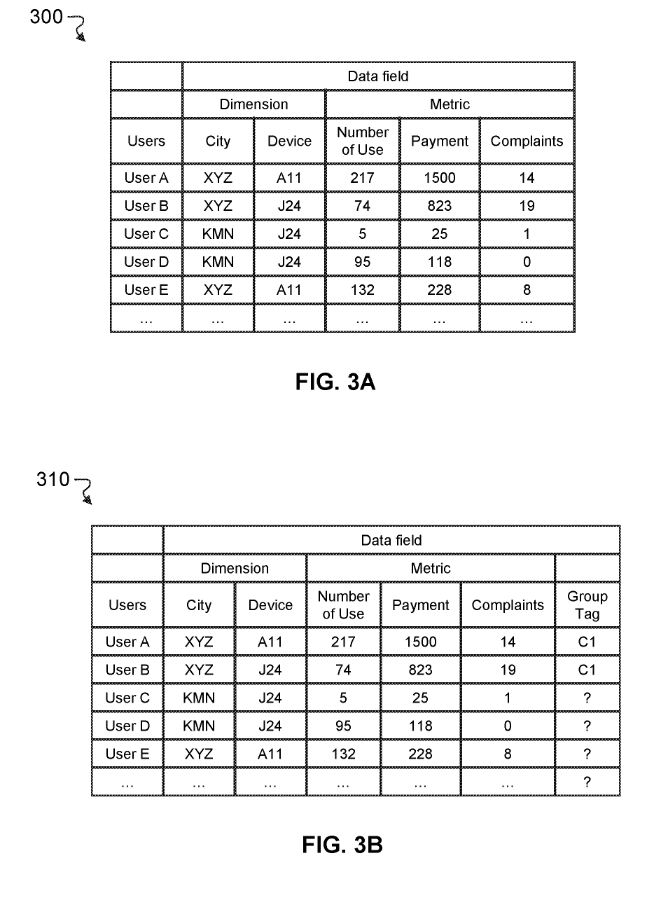

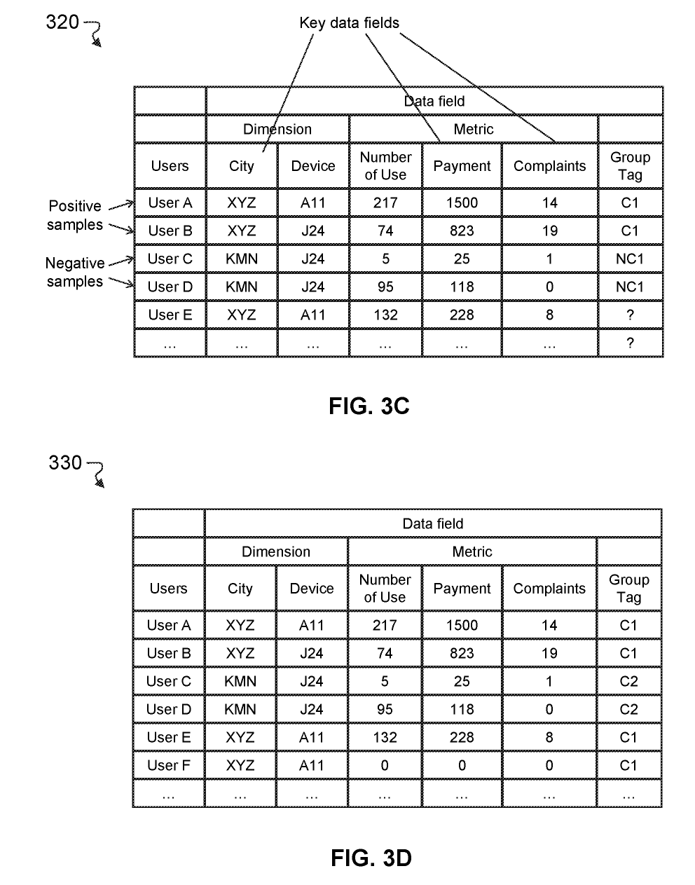

FIG. 2 illustrates an example system 200 for group tagging, in accordance with various embodiments. The operations shown in FIG. 2 and presented below are intended to be illustrative. In various embodiments, the computing device 120 may interact with the system 102 (e.g., registering new users, ordering services, transacting payments, etc.), and the corresponding information may be stored at least as a part of platform data 202 in the data stores 108, 109 and/or the memory 106, and accessible to the system 102. Further interactions among the system 200 are described below with references to FIGS. 3A-D.

Referring to FIG. 3A, FIG. 3A illustrates example platform data 300, in accordance with various embodiments. The description of FIG. 3A is intended to be illustrative and may be modified in various ways according to the implementation. The platform data may be stored in one or more formats such as tables, objects, etc. As shown in FIG. 3A, the platform data may comprise tabular data corresponding to each of the plurality of entities (e.g., Users such as User A, B, C, etc.) of the platform. The system 102 (e.g., sever) may be accessible to platform data comprising a plurality of users and a plurality of associated data fields (e.g., “City,” “Device,” “Number of use,” “Payment,” “Complaints,” etc.). For example, when a user registers with the platform, the user may submit corresponding account information (e.g., address, city, phone number, payment method, etc.), and from the use of the platform service, user history (e.g., device used to access the platform, number of service uses, payment transaction, complaints made, etc.) may also be recorded as platform data. The account information and user history may be stored in the various data fields associated with the user. In a table, the data fields may be presented as data columns. The data fields may include dimensions and metrics. The dimensions may comprise attributes of the data. For example, “City” indicates the city location of a user, and “Device” indicates the device used to access the platform. The metrics may comprise quantitative measurements. For example, “number of use” indicates a number of times the user has used the platform service, “Payment” indicates a total amount of transaction between the user and the platform, and “Complaints” indicates a number of times the user have complained to the platform.

In some embodiments, depending on their authorization levels, analysts and engineers (or other groups of people) of the platform may have different access levels to the platform data. For example, the analysts may include operation, customer service, and technical support teams. In their interaction with platform users, the analysts may only have access to data in “Users,” “City,” and “Complaints” columns and only have authorization to edit the “Complaints” column. The engineers may include data scientists, back-end engineers, and researcher teams. The engineers may have full access and authorization to edit all columns of the platform data 300.

Referring back to FIG. 2, computing devices 110 and 111 may be controlled and operated by analysts with limited access and authorization to the platform data. Based on user interaction or other experiences, the analysts may determine “local rules” to tag some users. For example, the analysts may tag a first user subset of the platform users and submit the tag information 204 (e.g., user IDs for the first user subset) to the system 102. Referring to FIG. 3B, FIG. 3B illustrates example platform data 310 with first tags, in accordance with various embodiments. The description of FIG. 3B is intended to be illustrative and may be modified in various ways according to the implementation. The platform data 310 is similar to the platform data 300 described above, except for the addition of the first tags C1. The system 102 may obtain a first subset of users from the plurality of users and the one or more first tags associated with the first subset of users (e.g., by receiving the first user subset and tag information 204). The platform data may not comprise the first tags before the system 102 (e.g., server) obtaining the first subset of users. The system 102 may incorporate the obtained information (e.g., the tag information 204) to the platform data (e.g., by adding the “Group tag” column to the platform data 300). The first user subset identified by the analysts may include “User A” corresponding to “14” complaints and “User B” corresponding to “19” complaints. The analysts may have tagged both “User A” and “User B” as “C1.” At this stage, tagging “User A” and “User B as “C1” may be referred to as a “local rule,” and it is to be determined how this “local rule” can be synthesized and extrapolated to other platform users as a “global rule.”

Referring back to FIG. 2, computing device 112 may be controlled and operated by engineers with full access and authorization to the platform data. Based on the “local rules” and the platform data, the engineers may send queries 206 (e.g., instructions, commands, etc.) to the system 102 to perform the learning-based group tagging. Referring to FIG. 3C, FIG. 3C illustrates example platform data 320 with determined positive and negative samples and key data fields, in accordance with various embodiments. The description of FIG. 3C is intended to be illustrative and may be modified in various ways according to the implementation. The platform data 320 is similar to the platform data 310 described above. Once obtaining the first user subset and tag information 204, the system 102 may determine, respectively for one or more of the associated data fields, at least a difference between the first subset of users and at least a part of the plurality of users. For example, the system 102 may determine, respectively for one or more of the “City,” “Device, “Number of use,” “Payment,” and “Complaints” columns, at least a difference (e.g., a Kullback-Leibler divergence) between the data of the first subset of users (e.g., User A and User B) and the data of at least a part of the platform users (e.g., all platform users, all platform users except for User A and User B, the next 500 users, etc.).

In response to determining the difference exceeding a first threshold, the system 102 may determine the corresponding data field as a key data field, and determine data of the corresponding one or more key data fields associated with the first subset of users as positive samples. This first threshold may be predetermined. In this disclosure, the predetermined threshold or other property may be preset by the system (e.g., the system 102) or operators (e.g., analysts, engineers, etc.) associated with the system. For example, by analyzing the “Payment” data of the first user subset against that of other platform users (e.g., all other platform users), the system 102 may determine that the difference exceeds a first predetermined threshold (e.g., above an average of 500 of all other platform users). Accordingly, the platform 102 may determine the “Payment” data field as a key data field and obtain “User A-Payment 1500-Group Tag C1” and “User B-payment 823-Group Tag C1” as positive samples. In some embodiments, the key data fields may include more than one data field, and the data fields can include dimension and/or metric, such as “City” and “Payment.” In this case, “User A-City XYZ-Payment 1500-Group Tag C1” and “User B-City XYZ-payment 823-Group Tag C1” may be used as positive samples. Here, the first predetermined threshold for data field “City” may be that cities in different provinces or states.

Based on the one or more key data fields, the system 102 may obtain a second subset of users from the plurality of users and associated data of the second subset of users from the platform data as negative samples. The system 102 may assign a tag to the negative samples for training. For example, the system 102 may obtain “User C-City KMN-Payment 25-Group Tag NC1” and “User D-City KMN-payment 118-Group Tag NC1” as negative samples. In some embodiments, the second subset of users may be different from the first subset of users over a third threshold (e.g., a third predetermined threshold) based on a similarity measurement with respect to the one or more key data fields. The similarity measurement can determine how similar a group of users is to another group, by obtaining a “distance” among the one or more key data fields associated with different users or user groups and comparing with distance thresholds. The similarity measurement can be implemented by various methods, such as (standardized) Euclidean distance method, Manhattan distance method, Chebyshev distance method, Minkowski distance method, Mahalanobis distance method, Cosine method, Hamming distance method, Jaccard similarity coefficient method, correlation coefficient and distance method, information entropy method, etc.

In one example of implementing the Euclidean distance method, the “distance” between two users S and T is \sqrt{(m1−m2)²}, if the user S has a property m1 for a data field and the user T has a property m2 for the same data field. Similarly, the distance between two users S and T is \sqrt{(m1−m2)²+(n2−n2)²}, if the user S has properties m1 and n1 for two data fields respectively and the other user T has properties m2 and n2 for the corresponding data fields. The same principle applies with even more data fields. Further, many methods can be used to obtain the “distance” between two groups of users. For example, every pair of users from two groups can be compared, user properties of users in each group can be averaged or otherwise represented by one representing user to compare with that of another representing user, etc. As such, the distances among the plurality of uses or user groups can be determined, and a second subset of users sufficiently away (having a “distance” above a preset threshold) from the first subset of users can be determined. The data associated with the second subset of users can be used as negative samples.

In another example of implementing the Cosine method, various properties (m1, n1, . . . ) of a user S and various properties (m2, n2, . . . ) of another user T can be treated as vectors. The “distance” between the two users is the angle between the two vectors. For example, the “distance” between users S (m1, n1) and T (m2, n2) is θ, where

$$cos θ = \frac{m 1 m 2 + n 1 n 2}{\sqrt{{m}_{1}^{2} + {n}_{1}^{2}} + \sqrt{{m}_{2}^{2} + {n}_{2}^{2}}} .$$

cos θ is in the range between −1 and 1. The closer cos θ is to 1, the more similar the two users are to each other. The same principle applies with even more data fields. Further, many methods can be used to obtain the “distance” between two groups of users. For example, every pair of users from two groups can be compared, user properties of users in each group can be averaged or otherwise represented by one representing user to compare with that of another representing user, etc. As such, the distances among the plurality of uses or user groups can be determined, and a second subset of users sufficiently away (having a “distance” above a preset threshold) from the first subset of users can be determined. The data associated with the second subset of users can be used as negative samples.

The Euclidean distance method, Cosine method, or another similarity measurement method can also be directly used or modified into a k-nearest neighbor method. A person skilled in the art would appreciate that the k-nearest neighbor determination can be used for classification or regression based on the “distance” determination. In an example classification model, an object (e.g., platform user) can be classified by a majority vote of its neighbors, with the object being assigned to the class most common among its k nearest neighbor. In an 1-D example, for a metric column, square root differences between data of the first subset users and data of other users can be calculated, and users corresponding to a difference from the first subset users above a third predetermined threshold can be used as negative samples. As the number of key data fields increases, the complexity scales up. Thus, simple ordering and thresholding a single column data becomes inadequate to synthesize the “global tagging rule,” and model training is applied. To that end, objects (e.g., platform users) can be mapped out according to their properties (e.g., data fields). Each portion of congregated data points may be determined as a classified group by the k-nearest neighbor method, such that a group corresponding to the negative samples are away from another group corresponding to the positive samples above the third predetermined threshold. For example, if a user corresponds to two data fields, the user can be mapped on a x-y plane with each axis corresponding to a data field. An area corresponding to the positive samples on the x-y plane is away from another area corresponding to the negative samples for a distance above the third predetermined threshold. Similarly, in cases with more data fields, data points can classified by the k-nearest neighbor method, and the negative samples can be determined based on a substantial difference from the positive samples.

In some embodiments, the system 102 may train a rule model (e.g., a decision tree rule model) with the positive and negative samples until reaching a second accuracy threshold to obtain a trained group tagging rule model. A number of parameters may be configured for the rule model training. For example, the second accuracy threshold may be preset. For another example, the depth of the decision tree model may be preset (e.g., three levels of depth to limit the complexity). For yet another example, the number of decision trees may be preset to add “or” conditions for decision making (e.g., parallel decision trees can represent “or” conditions and branches in the same decision tree can represent “and” conditions for determining group tagging decisions). Thus, with both “and” and “or” conditions, the decision tree model can have more flexibility in decision making, thus improving its accuracy.

A person skilled in the art would understand that the decision tree rule model can be based on decision tree learning which uses a decision tree as a predictive model. The predictive model may map observations about an item (e.g., data field values of a platform user) to conclusions of the item's target value (e.g., tag C1). By training with the positive samples (e.g., samples that should be tagged C1) and negative samples (e.g., samples that should not be tagged C1), the trained rule model can comprise logic algorithms to automatically tag other samples. The logic algorithms may be consolidated based at least in part on decisions made at each level or depth of each tree. The trained group tagging rule model may determine whether to assign one or more of the plurality of users the first tags, and tag one or more of the platform users and/or new users added to the platform, as shown in FIG. 3D. The description of FIG. 3D is intended to be illustrative and may be modified in various ways according to the implementation. For example, applying the trained rule model to the platform users, system 102 may tag “User C” and “User D” as “C2,” and tag “User E” as “C1.” Further, the train model may also include “City” as a key data field with a more significant weight than that of “Payment.” Accordingly, the system 102 may tag a new user “User F” as “C1,” even though the new user has no transaction with the platform yet. Thus, the group tagging rule can be used to both analyze existing data and predict group tags for new data.

Referring back to FIG. 2, with the group tagging rule trained and applied to the platform data, computing device 111 (or computing device 110) can view the group tags by sending query 208 and receive tagged user 210. Further, the computing device may refine the trained group tagging rule model via the query 208, for example, by correcting the tags for one or more users. If computing device 120 registers a new user with the system 102, the “global tagging rule” can be applied to predicatively tag the new user.

In view of the above, the “local tagging rules” having a high level of reliability and accuracy can be synthesized by comparing with other platform data to obtain “global tagging rules.” The “global tagging rules” incorporate the characteristics defined in the “local tagging rules” and are applicable across the platform data. The process can be automated by the learning process described above, thus achieving the group tagging task unattainable by the analysts with a high efficiency.

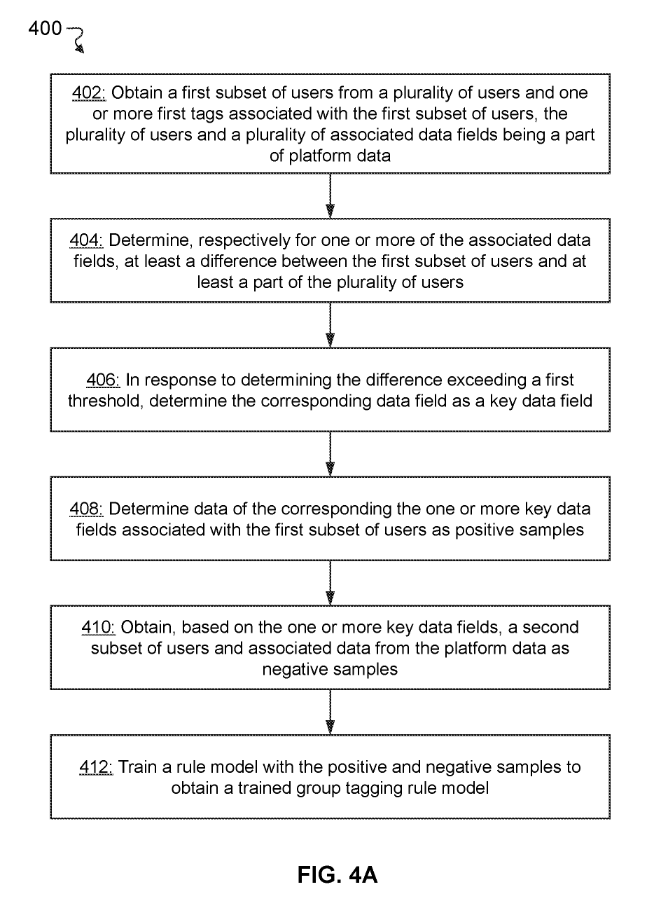

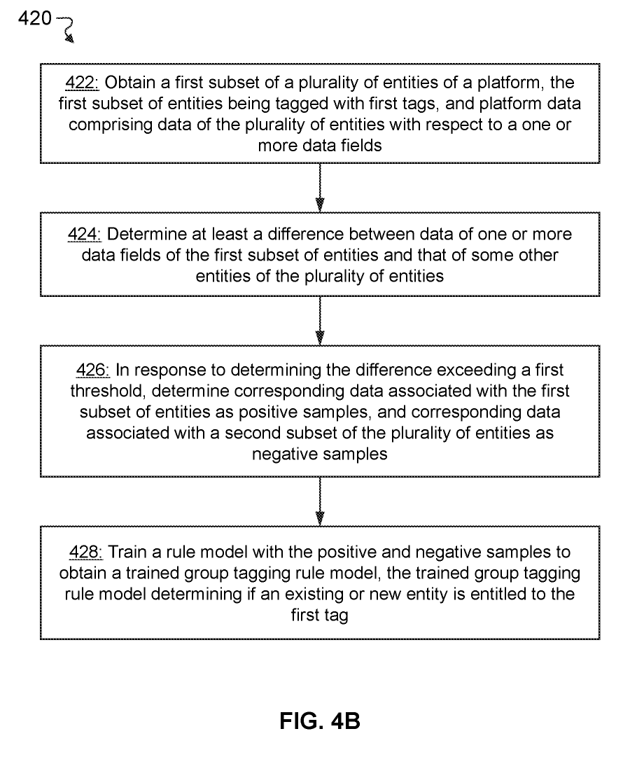

FIG. 4A illustrates a flowchart of an example method 400, according to various embodiments of the present disclosure. The method 400 may be implemented in various environments including, for example, the environment 100 of FIG. 1. The operations of method 400 presented below are intended to be illustrative. Depending on the implementation, the example method 400 may include additional, fewer, or alternative steps performed in various orders or in parallel. The example method 400 may be implemented in various computing systems or devices including one or more processors of one or more servers.

At block 402, a first subset of users may be obtained from a plurality of users, and one or more first tags associated with the first subset of users may be obtained. The plurality of users and a plurality of associated data fields may be a part of platform data. The first subset may be obtained first-hand from analysts or operators. At block 404, at least a difference between the first subset of users and at least a part of the plurality of users may be determined respectively for one or more of the associated data fields. At block 406, in response to determining the difference exceeding a first threshold, the corresponding data field may be determined as a key data field. The block 406 may be performed for one or more of the associated data fields to obtain one or more key data fields. At block 408, data of the corresponding the one or more key data fields associated with the first subset of users may be obtained as positive samples. At block 410, based on the one or more key data fields, a second subset of users may be obtained from the plurality of users, and associated data from the platform data may be obtained as negative samples. The negative samples may be substantially different from the positive samples, and can be obtained as discussed above. At block 412, a rule model may be trained with the positive and negative samples to reach a second accuracy threshold to obtain a trained group tagging rule model. The trained group tagging rule model can be applied to tag the plurality of users and new users added to the plurality of users, such that the users can be automatically organized in desirable categories.

FIG. 4B illustrates a flowchart of an example method 420, according to various embodiments of the present disclosure. The method 420 may be implemented in various environments including, for example, the environment 100 of FIG. 1. The operations of method 420 presented below are intended to be illustrative. Depending on the implementation, the example method 420 may include additional, fewer, or alternative steps performed in various orders or in parallel. The example method 420 may be implemented in various computing systems or devices including one or more processors of one or more servers.

At block 422, a first subset of a plurality of entities of a platform is obtained. The first subset of entities are tagged with first tags, and platform data comprises data of the plurality of entities with respect to a one or more data fields. At block 424, at least a difference is determined between data of one or more data fields of the first subset of entities and that of some other entities of the plurality of entities. At block 426, in response to determining the difference exceeding a first threshold, corresponding data associated with the first subset of entities as positive samples are obtained, and corresponding data associated with a second subset of the plurality of entities as negative samples are obtained. The negative samples may be substantially different from the positive samples, and can be obtained as discussed above. At block 428, a rule model is trained with the positive and negative samples to obtain a trained group tagging rule model. The trained group tagging rule model determines if an existing or new entity is entitled to the first tag.

The techniques described herein are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques. Computing device(s) are generally controlled and coordinated by operating system software. Conventional operating systems control and schedule computer processes for execution, perform memory management, provide file system, networking, I/O services, and provide a user interface functionality, such as a graphical user interface (“GUI”), among other things.

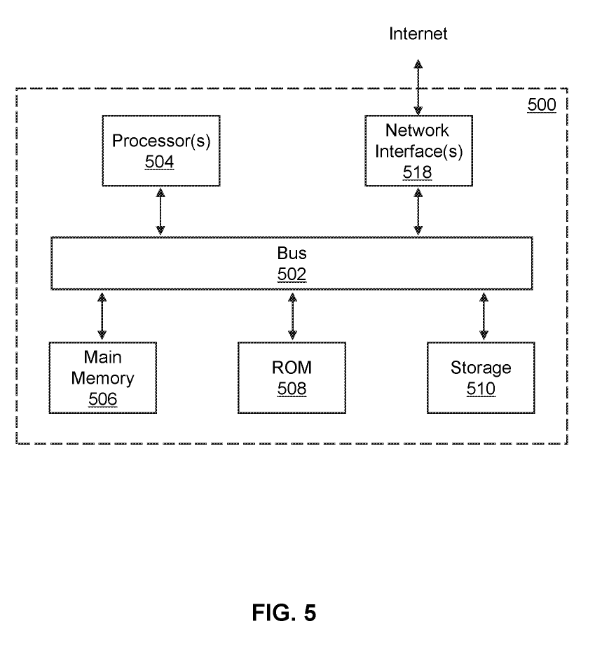

FIG. 5 is a block diagram that illustrates a computer system 500 upon which any of the embodiments described herein may be implemented. The system 500 may correspond to the system 102 described above. The computer system 500 includes a bus 502 or other communication mechanism for communicating information, one or more hardware processors 504 coupled with bus 502 for processing information. Hardware processor(s) 504 may be, for example, one or more general purpose microprocessors. The processor(s) 504 may correspond to the processor 104 described above.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions. The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions. The main memory 506, the ROM 508, and/or the storage 510 may correspond to the memory 106 described above.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The main memory 506, the ROM 508, and/or the storage 510 may include non-transitory storage media. The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

The computer system 500 also includes a communication interface 518 coupled to bus 502. Communication interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN (or WAN component to communicated with a WAN). Wireless links may also be implemented. In any such implementation, communication interface 518 sends and receives electrical, electromagnetic or optical signals that carry digital data streams representing various types of information.

The computer system 500 can send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, the term “or” may be construed in either an inclusive or exclusive sense. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

1. A system for group tagging, comprising:
one or more processors accessible to platform data, wherein the platform data includes a plurality of users and a plurality of data fields associated with the plurality of users; and
one or more memory storing instructions, wherein when the one or more processors execute the one or more memory storing instructions, the one or more processors:
obtain a first subset of users and one or more first tags associated with the first subset of users;
determine one or more key data fields by, for each of the one or more of the plurality of data fields,
determining at least a difference between the first subset of users and at least a part of the plurality of users; and
in response to a determination of the difference exceeding a first threshold, determining the corresponding data field as a key data field;
determine data of the corresponding one or more key data fields associated with the first subset of users as positive samples;
obtain, based on the one or more key data fields, from the platform data, a second subset of users and data associated with the second subset of users as negative samples; and
train a rule model with the positive samples and the negative samples to obtain a trained group tagging rule model.

2. The system of claim 1, wherein:
the platform data comprises tabular data corresponding to each of the plurality of users; and
the plurality of data fields comprises at least one of dimension or metric of the tabular data.

3. The system of claim 1, wherein:
the plurality of users are users of the platform;
the platform is a vehicle information platform; and
the plurality of data fields comprises at least one of a location, a number of uses, a transaction amount, or a number of complaints.

4. The system of claim 1, wherein to obtain the first subset of users, the one or more processors further receive identifications of the first subset of users from one or more entities without full access to the platform data.

5. The system of claim 1, wherein the platform data do not comprise the first tags before the one or more processors obtain the first subset of users.

6. The system of claim 1, wherein the difference is a Kullback-Leibler divergence.

7. The system of claim 1, wherein the second subset of users are different from the first subset of users over a third threshold based on a similarity measurement with respect to the one or more key data fields.

8. The system of claim 1, wherein the rule model is a decision tree model.

9. The system of claim 1, wherein the trained group tagging rule model is configured to determine whether to assign one or more of the plurality of users the first tags.

10. The system of claim 1, wherein the one or more processors further:
apply the trained group tagging rule model on the plurality of users and new users added to the plurality of users.

11. A method for implementing in a system for group tagging, comprising:
obtaining, by one or more processors, a first subset of users from a plurality of users and one or more first tags associated with the first subset of users, wherein the plurality of users and a plurality of data fields associated with the plurality of uses are part of platform data;
determine, by the one or more processors, one or more key data fields by, for each of the one or more of the plurality of data fields,
determining, by the one or more processors, at least a difference between the first subset of users and at least part of the plurality of users; and
in response to a determining determination of the difference exceeding a first threshold, determining, by the one or more processors, the corresponding data field as a key data field;
determining, by the one or more processors, data of the corresponding one or more key data fields associated with the first subset of users as positive samples;
obtaining, by the one or more processors, based on the one or more key data fields, from the platform data, a second subset of users and data associated with the second subset of users as negative samples; and
training a rule model with the positive samples and the negative samples to obtain a trained group tagging rule model.

12. The method of claim 11, wherein:
the platform data comprises tabular data corresponding to each of the plurality of users; and
the plurality of data fields comprises at least one of dimension or metric of the tabular data.

13. The method of claim 11, wherein:
the plurality of users are users of the platform;
the platform is a vehicle information platform; and
the plurality of data fields comprises at least one of a location, a number of uses, a transaction amount, or a number of complaints.

14. The method of claim 11, wherein the obtaining a first subset of users comprises receiving identifications of the first subset of users from one or more entities without full access to the platform data.

15. The method of claim 11, wherein the platform data do not comprise the first tags before the obtaining a first subset of users.

16. The method of claim 11, wherein the difference is a Kullback-Leibler divergence.

17. The method of claim 11, wherein the second subset of users are different from the first subset of users over a third threshold based on a similarity measurement with respect to the one or more key data fields.

18. The method of claim 11, wherein the rule model is a decision tree model.

19. The method of claim 11, further comprising:
applying the trained group tagging rule model on the plurality of users and new users added to the plurality of users.

20. A method for group tagging, comprising:
obtaining, by one or more processors, a first subset of a plurality of entities of a platform, wherein the first subset of the plurality of entities are tagged with first tags, and platform data of the platform comprises data of the plurality of entities with respect to one or more data fields;
determining at least a difference between data associated with the one or more data fields of the first subset of the plurality of entities and that of some other entities of the plurality of entities;
in response to a determination of the difference exceeding a first threshold, obtaining corresponding data associated with the first subset of the plurality of entities as positive samples, and corresponding data associated with a second subset of the plurality of entities as negative samples; and
training a rule model with the positive samples and the negative samples to obtain a trained group tagging rule model, wherein the trained group tagging rule model determines if an existing or new entity is entitled to the first tag.
